(19) United States
(12) Patent Application Publication
(10) Pub. No.: US 2019/0082328 A1
(43) Pub. Date: Mar. 14, 2019

(54) INTEGRATED OPEN-PIT OR UNDERGROUND MINES AND WIRELESS TRANSMISSION NETWORKS

(71) Applicant: VALE S.A., Rio de Janeiro (RJ) (BR)

(72) Inventors: Luís Guilherme Uzeda GARCIA, Belo Horizonte (BR); Erika Portela Lopes DE ALMEIDA, Aalborg (DK); Ignacio Rodriguez LARRAD, Aalborg (DK); Viviane da Silva Borges BARBOSA, Belo Horizonte (BR); George CALDWELL, Brasilia (BR)

(21) Appl. No.: 16/082,630

(22) PCT Filed: Mar. 8, 2017
(86) PCT No.: PCT/BR2017/000030

§ 371 Date: Sep. 6, 2018

(30) Foreign Application Priority Data
Mar. 10, 2016 (BR) 102016005371-4

(51) Int. Cl. H04W 16/20; H04L 12/24; H04W 24/02; E21C 41/00

(52) U.S. Cl. CPC H04W 16/20; E21C 41/00; H04W 24/02; H04L 41/14

(57) ABSTRACT

The disclosure provides a method that comprises the combination of two processes: Mine Planning and Network Planning. The fusion of these two processes can reduce the operation costs of a mine, enable the installation of a cheaper wireless network, and provide a higher quality and coverage that better meet the operation needs of the mine.

### CROSS-REFERENCE TO RELATED APPLICATIONS

This application is a 35 U.S.C. § 371 National Stage of PCT Application No. PCT/BR2017/000030 filed Mar. 8, 2017, which claims priority to Brazilian Application No. BR 102016005371-4 filed Mar. 10, 2016, the disclosure of both is hereby incorporated by reference herein.

### FIELD

This disclosure relates to the areas of Mine Planning and Wireless Network Planning for open-pit and underground mines.

### BACKGROUND

For the two processes of Mine Planning and Network Planning, the trend of automation of processes and robotization of operations makes the communications subsystem an essential component to the extraction operations. The two processes were always presented separately in the technique status, because until now the potential for synergy between them was not known.

Preliminarily, so that this disclosure is understood in its full integrity, it must be defined what is “Mine Planning” and what is “Network Planning”.

Network Planning is the planning before the installation of a wireless transmission network on any environment. Wireless transmission networks are very common in open-pit and underground mines, where a communication network with high availability, ultra-reliable, with very low error rates (packet loss) and low latency is required, so that maximum safety, productivity and efficiency standards are achieved.

There are several types of wireless networks, and the most common are those which employ a combination of fixed antennas 2, portable routers 3 and onboard routers 3′ (linked to the bodies of trucks, shovels and other machines involved in the mining operation). See FIG. 3 of this disclosure.

For all vehicles 8 and units in a mine 1, 4 to be able to communicate with each other, transmitting and collecting data from each other, we need a communication network structure that meets the mine work extension, covering the entire operating area, such as the traffic areas and destination areas of equipment.

As the calculation of the distribution of nodes is very complex, wireless network planning operation is usually performed by using a specialized software. Examples of software that can perform this operation are given below:
ASSET™ network planning tool
MENTUM PLANET™ network planning tool
WINPROP™ radio planning tool
WIRELESS INSIGHT™ propagation software (with ray-tracing models).

The standard procedure for planning and optimization using such software works very well for less dynamic (“clutter”) topography and morphology environments, such as cities and rural areas. However, as the topography of a mine changes constantly, any planning, especially broadband, becomes obsolete in a short time. This, in practice, involves a series of reactive and expensive redesigns over the entire length of mine lifecycle.

Mine Planning is planning that is performed prior to the extraction phase of a mine, i.e., the phase of removal of material from an orebody.

Based on data obtained during the exploration phase of the mine, such as data from sampling and geophysical profiling, the productive area of the mine is mapped. In this phase, the deposit points where there is a higher concentration of minerals are determined and a three-dimensional map of the productive areas is outlined.

The Mine Planning phase is the development of a project for access and extraction of ore producing areas. In an open-pit extraction, the mine is divided into virtual three-dimensional blocks (see FIG. 11), then the sequencing of extraction of these blocks 10, 11 is planned, in order to promote saving of resources, ease of machinery access, and maximizing financial returns to operation.

In practice, the Mine Planning aims to remove the most quantity of ore to a smaller volume of waste rock material, therefore maximizing the net present value of the mine. In this way, dividends are maximized and resources of this operation are saved.

Just like the network planning applied to the Wireless Network Planning, the mine planning must be frequently revised throughout the mine lifecycle, based on changes to the data collected during the mineral exploration phase.

Some of the tools currently available in the market for Mine Planning are:
VULCAN™ mining software
GEOVIA WHITTLE™ mining software
DATAMINE™ mining software
MINESIGHT™ mining software
GEOPIT™ mining software.

To date, there is no method or software that is able to perform the Integrated Planning of a Mine and its support Network, in order to optimize the operation of both, bringing economic gains to these operations.

### SUMMARY

An aspect of the disclosure is a new method of Network Planning that input data provided by a method of Mine Planning.

An aspect of the disclosure is a new method of Mine Planning that input data provided by a method of Network Planning.

An aspect of the disclosure is a more economical method of Network Planning.

An aspect of the disclosure is a more economical method of Mine Planning.

An aspect of the disclosure is to manipulate the topography of a mine and, therefore, radio propagation, so as to confine the radio signals to the area of interest, minimizing unintended leaks, in order to increase security of the information used by operations.

Finally, an aspect of the disclosure is to allow the manipulation of the topography of a mine and, therefore, radio propagation, so as to block external radio signals of unintended interference, in order to increase to protect the critical radio links used by operations.

### BRIEF DESCRIPTION OF DRAWINGS

This disclosure is more described in detail, based on the respective figures:

FIG. 1—A top view of an open-pit extraction mine, revealing a blind spot in its wireless network coverage area.

FIG. 2—A top view of the open-pit extraction mine of FIG. 1, with the blind spot issue solved by the use of these aspects.

FIG. 3—A representation of a wireless network coverage area comprising base stations, fixed relays and mobile relays operating jointly.

FIG. 4—A cut view of an underground mine fitted with a series of relays set to give support to the wireless communication network of the mine.

FIG. 5—A cut view of an underground mine with an interference point in the communication network of the mine.

FIG. 6—A cut view of the underground mine of FIG. 5 with a solution brought by the method of these aspects.

FIG. 7—A flowchart of a first form of execution of these aspects.

FIG. 8—A flowchart of a second form of execution of these aspects.

FIG. 9—A flowchart based on the form of execution of FIG. 7.

FIG. 10—A flowchart based on the form of execution of FIG. 8.

FIG. 11—A block model representation understood by the technique status.

### DETAILED DESCRIPTION

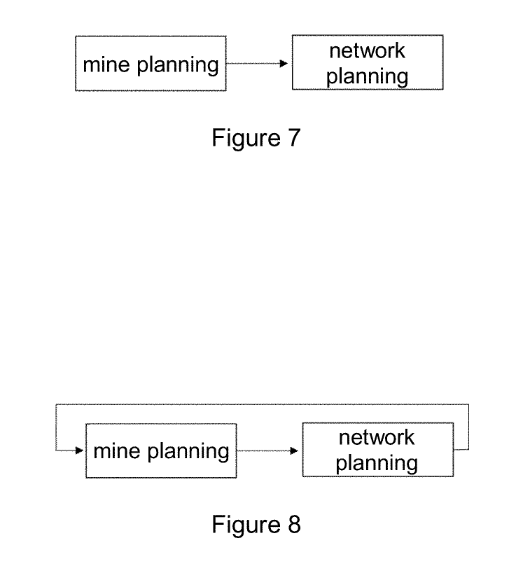

In a simplified way, an aspect of this disclosure, as shown in FIGS. 7 and 8, is the combination of a method of Mine Planning with a method of Network Planning.

The new tool makes available the data from Mine Planning as inputs to Network Planning. In other words, with the new tool, the layout planning of nodes 3, 3′, 2 of the wireless network will take into account the current and future provisions of mine topography 1, 4 (see FIG. 7).

Without a synchronization between the two methods (mine planning and network planning), in the technique status, the wireless Network Planning of a mine is made in a sub-optimal manner—possibly erratic and timely—every time connectivity failures appears.

Before performing any Network Planning, it is necessary to understand the propagation of radio waves. This propagation is strongly influenced by the relief, which, in turn, is continuously changed by following by mining after a mine planning. Finally, coordination and execution of own mining, especially in scenarios with a high degree of automation, rely on wireless connectivity. In this sense, base stations and fixed nodes 3 are positioned where it is believed there will be a future need for network coverage. The nodes 2, 3, 3′ are oriented so as to cover the current and future mine topography, being installed in an amount and layout which are expected to be able to circumvent further barriers and cover future topography, depths and contours quite distinct from original topographies in the initial phase of mine exploration 1, 4.

There are service providers in the technique status, as the company United Mine Solutions (USA), which say they can provide a network planning that anticipate the current and future needs of a mine 1, 4. It happens that these service providers make the Network Planning based on the experience and intuition of their employees. In the technique status, there is no method 100% reliable and independent of human intervention for a Network Planning that meets all current and future needs of a mine 1, 4.

This disclosure, therefore, includes the only organized and effective means of defining a Network Planning that can design a wireless network that promotes a coverage area 6 without gaps or blind spots in the early, final and intermediate stages of the exploitation phase of a mine 1, 4, regardless of the topographical changes that have occurred in the mine 1, 4 in these periods.

In its second form of execution, see FIG. 8, the method of Network Planning also provides input to the method of Mine Planning. The purpose behind this loop (see upper arrow in FIG. 8) is to provide adaptations to the topographic profile of the mine that promote wireless network improvements.

To understand this point, we must preliminarily understand that radio waves 7 emitted by the wireless equipment can be absorbed, reflected, deflected or scattered by different types of materials found in the mine 1, 4.

In general, specular reflections occur when the electromagnetic wave falls upon a surface—particularly metallic—which dimensions are much greater than its wavelength. Diffraction occurs most prominently when the way taken by radio wave 7—the path between the transmitter and receiver—is blocked by an obstacle or slit with dimensions comparable to the wavelength, resulting in bending the wave around the obstacle. The scattering (diffuse reflection), in turn, occurs when the wavefront falls upon an uneven surface or when the medium through which the wave propagates comprises objects which dimensions are comparable to the wavelength. Finally, the absorption is a physical phenomenon in which part of energy (photons) of the wave interacts with the environment (typically electrons), being converted into thermal energy.

So far, these effects caused by the materials and the topography of mines 1, 4 on radio waves 7 were just a problem to be overcome (not foreseen) by the Network Planning. Any deviation, attenuation or reflection caused by materials found in mines 1, 4 was seen as an obstacle to be overcome by the Network Planning. After completing this disclosure, these ways of interaction between radio waves 7 and the materials present in the mine 1, 4 will be interpreted as “forms of generation of favorable RF condition”.

A favorable RF condition is defined as the presence of signal and absence of interference above acceptable thresholds in the areas of interest (or the reverse to avoid signal leaks). Before this disclosure, any deviation, attenuation or reflection caused by topography and lithology of the mine were seen as obstacles to be overcome by the Network Planning. After completing this disclosure, the interaction between radio waves and the mine environment, also considering the topographical change, is now estimated by the Network Planning. In addition, the mine topography features can be manipulated to achieve the specific purposes of planning, such as interference confinement. For example, it is known that the presence of obstacles within the first Fresnel zone, which radius can be calculated mathematically, significantly changes the signal level at the receiver.

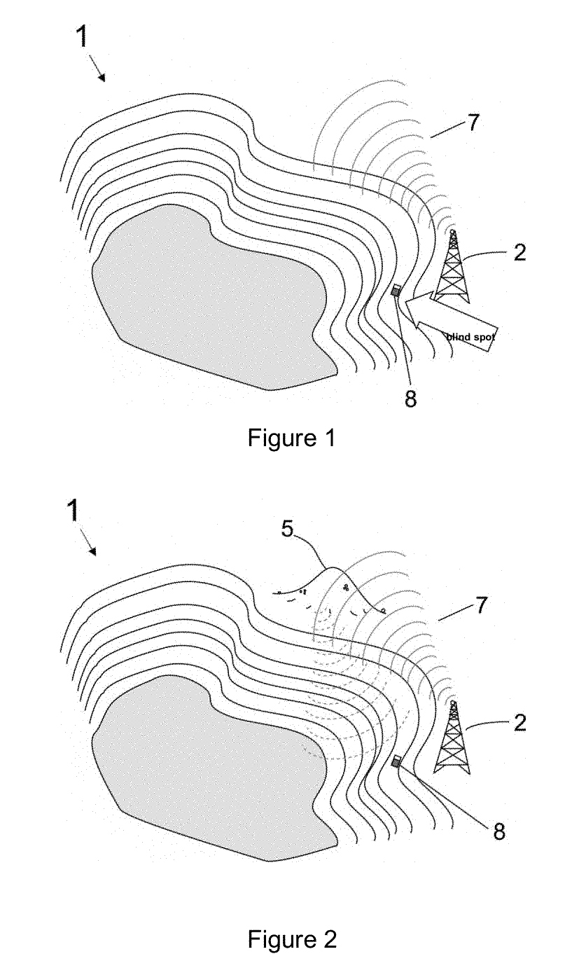

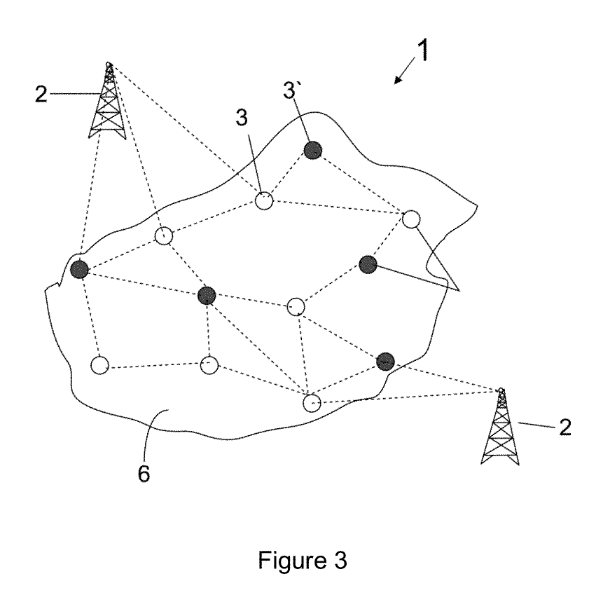

It is possible, for instance, to allocate a deposit of waste rock material in a specific area around a mine so that this element works as a reflective screen 5 and reflects radio waves 7 to extinguish a blind point in a network coverage area 6 (see FIGS. 1 and 2).

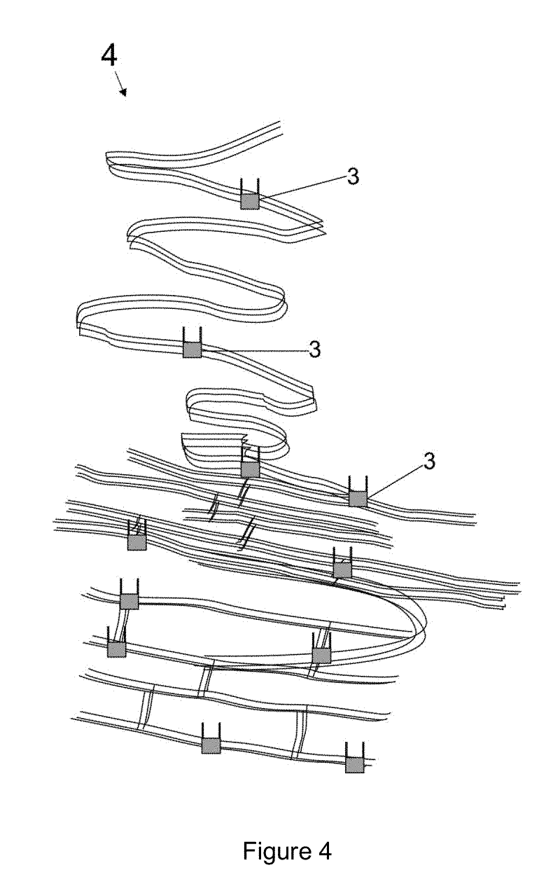

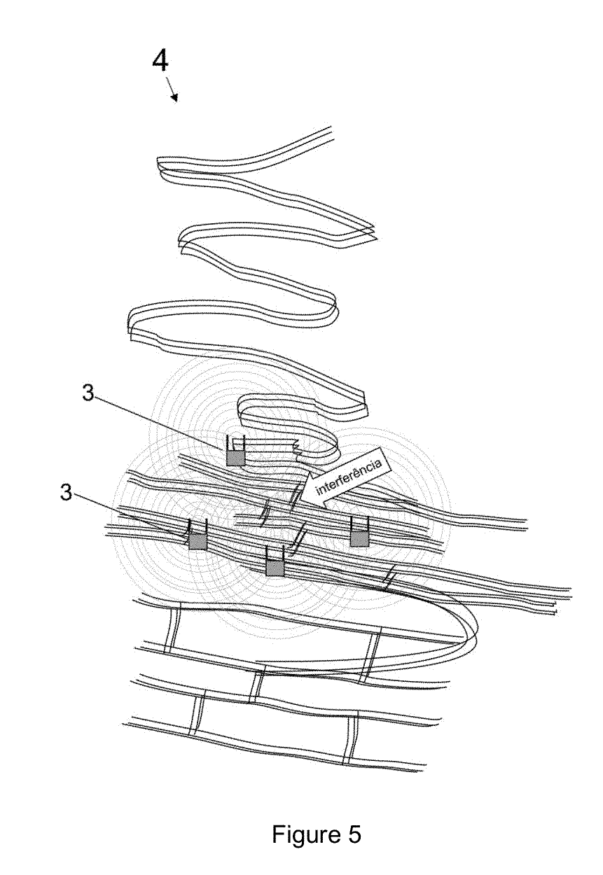

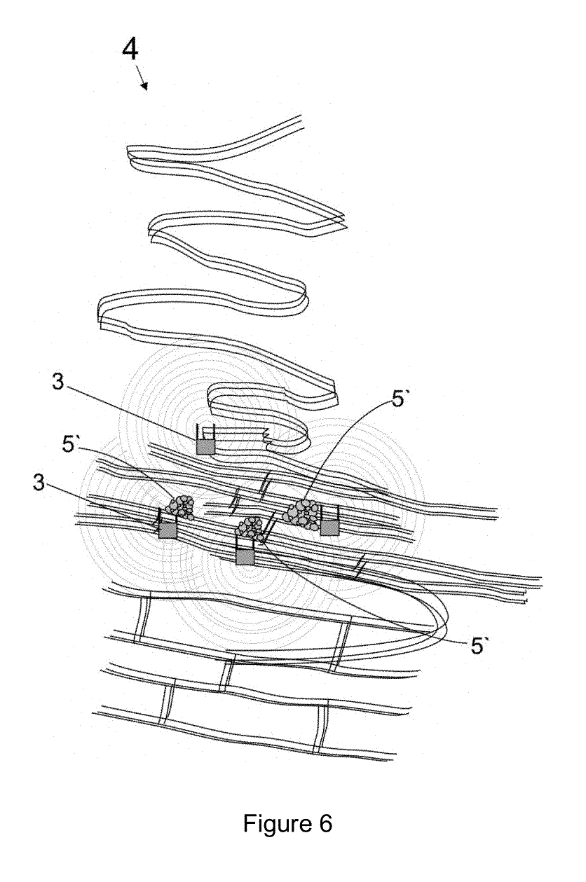

Another option would be to create barriers (absorption shields 5′) to contain the interference in underground extraction mines 4 (see FIGS. 4, 5 and 6 of this document).

One option not revealed in the figures is the creation of additional tunnels acting as waveguides in an underground mine 4 to expand the network coverage area 6 inside the underground mine 4.

Other examples of topographical changes in the mine that influence the propagation of RF signals include: small adjustments to the mine sequencing, non-permanent filler of intermediate pits, and creation of surface/mobile screens to confine the signal in an open-pit mine. Small adjustments to the mine sequencing allows, for example, that the removal of an obstacle in the propagation environment is delayed. This obstacle may be a hill which attenuates the signal from the transmitter, but allows the interference confinement between different transmitters.

All possible ways of generating a favorable RF condition are not limited to these examples. Several other forms of interaction could be designed, since these interactions between materials and radio waves 7 could contribute to the operation of the wireless network.

By using “forms of generation of favorable RF condition”, this disclosure allows reducing the number and capacity of the nodes 3, 3′ and antennas 2 distributed in the mine 1, 4.

In this mode of the disclosure (described in FIG. 8 of this report), the Mine Planning considers, in addition to conventional variables, such as location of waste rock material blocks 10 and ore blocks 11 variables capable of hampering or facilitating the completion of a wireless network on the entire mine surface 1, 4.

In other words, in this mode of execution, the Mine Planning looks for cheaper alternatives for exploitation of the mine 1, 4, considering not only the costs involved in the removal and transportation of ore and waste rock material inside the mine 1, 4 for their discharge points (such as deposits of waste rock or primary crushers), but also take into account the cost of wireless network installation for each of these forms of access and exploitation.

The ideal Mine Planning, according to this logic, is the one with the lowest possible execution costs, including material extraction, transportation and processing costs, and the cost of installation of the wireless network.

A synchronization of these two methods, Mine Planning and Network Planning, can be made in several ways, including:
The development of a unique method that perform the Mine Planning and Network Planning simultaneously.
A framework that uses two different methods, one of them related to Mine Planning and another related to Network Planning. In this execution of the disclosure, an operator would be in charge of transferring the mine planning inputs to network planning, and vice-versa.
A method that does not use software, but executes the Mine Planning and Network Planning simultaneously by performing manual calculations and planning.

The first form of execution of the disclosure (FIG. 7) can also be divided into the following steps:
I—Collect information of Mine Planning: This step corresponds to access to future topography of the mine, the lithology and the number and profile of elements comprised by the mine 1, 4, such as trucks, drills and wheel loaders, and other equipment necessary for the complete extraction of the mine within a previously stipulated period of time.
II—Assess the network requirements: Based on the elements defined in step I, find the network requirements of these elements. For example, if only narrow band communication is required, or if broad band communication is required concurrently or entirely. Also assess: what is the maximum delay and jitter acceptable for each node; the coverage capacity of each node; the number of autonomous nodes within the network; and the size of the area to be covered.
III—Plan the network infrastructure: Based on the network requirements and Mine Planning inputs, select the best possible layout for the wireless network distribution for current and future mine topography. Considering the medium-term changes in the topography, choose a layout that minimizes network costs while complying to the network requirements of elements comprised inside the mine.
IV—Install the network: Effectively distribute relays 3, 3′, antennas 2 and other devices that give support to network.
V—Operate the mine: This step consists of the mine exploitation phase. In this step, blocks of waste rock or ore material are removed, according to Mine Planning. Consequently, this step changes the mine topography.
VI—Assess the network performance indicators: collect real and simulated indicators, considering the changes in mine topography 1, 4.
VII—Are indicators compatible with current and future requirements? This step consists of comparing the indicators collected with the performance requirements. This step is performed so that the system operator may make a decision to optimize the system, if required. If the indicators are in accordance with the necessary requirements, it returns to step V.
VIII—Can the network be improved? This phase consists of the assessment of the possibility or not to optimize network parameters, such as: positioning of nodes 3, 3′, 2, transmission power, inclination of antenna 2, transmission modes, or even to generate a favorable RF condition. if it is possible, go to step IX to optimize the parameters; if not, assess if it is required to redesign the connectivity of the network infrastructure in step X.
IX—Network optimization: Changes the parameters identified in step VIII, returning to step VI to reassess the performance indicators.
X—Collect update information of the mine: It is known that the real mine environment does not follow the Mine Planning exactly. Therefore, from time to time, it is necessary to assess how close is the Mine Planning from the real topography of the mine. This information is very important for Network Planning.
XI—Does the network needs more from us? Based on information collected in step X, assess if more nodes 3, 3′ and 2 are required for the network infrastructure. If more nodes 3, 3′, 2 are required, go to step XII. If not, go to step XIII.
XII—Add nodes: Add extra nodes 3, 3′, 2 to the network structure, then return to step IV.
XIII—Is it required to redesign the network? In this step, it is assessed the requirement to redesign the network. One of the reasons that may result in this Network redesign being unnecessary is the mine closure 1, 4. If it is required to redesign the network, return to step II.

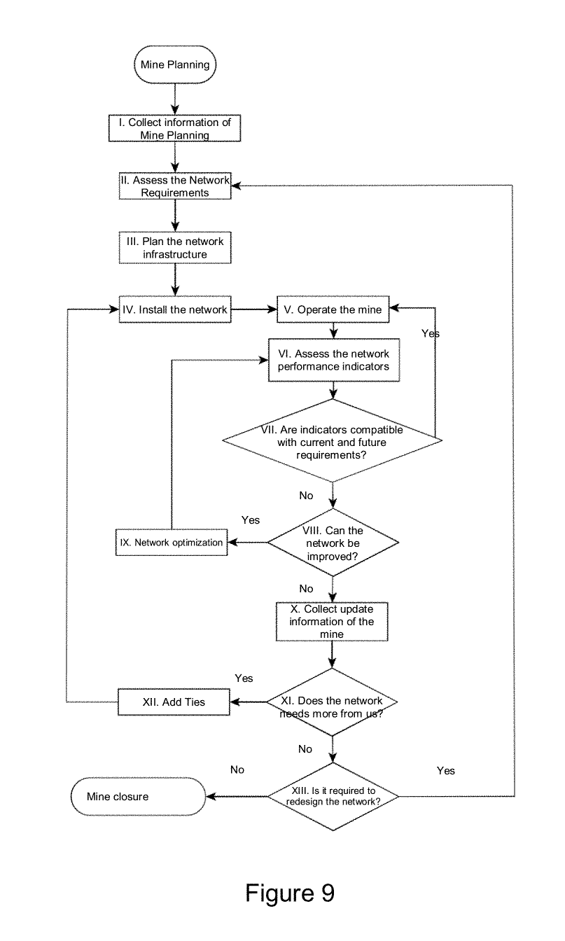

A representative flow chart of the steps listed is shown in FIG. 9 of this document.

The second form of execution of the disclosure (FIG. 8), in turn, can be divided into the following steps:
I—Mine Planning: In this step, the final layout of the mine (the final-pit of an open-pit mine 1) and the order of mines to be extracted are determined in accordance with specific algorithms. It is noted that, in this implementation, the Mine Planning also receives an input from topographies favorable to wireless network. In this case, the Net Value of the mine 1, 4 also considers the long-term costs of the wireless infrastructure, being used to program the mine layout 1, 4 in a more profitable way.
II—Collect Mine Planning data: This phase corresponds to the assessment of future topography of the mine 1, 4, lithology and elements, such as trucks, drills and wheel loaders, required to operate the mine 1,4 within a planned schedule. This step comprises the obtainment of Mine Planning information in a future period, so that the actions taken to optimize and redesign the network consider its future growth.
III—Assess the network requirements: based on the elements defined in the previous step, find the network requirements of these elements. For example, if only narrow band communication is required, or if broad band communication is required concurrently or entirely. Also assess: the maximum delay and jitter acceptable for each node; the coverage capacity of each node; the number of autonomous nodes within the network; and the size of the area of network coverage 6.
IV—Plan the network infrastructure: Based on the network requirements and Mine Planning inputs, select the best possible layout for the wireless network distribution for current and future mine topography 1, 4. Considering the medium-term changes in the topography, choose a layout that minimizes network costs while keeping the network requirements of elements comprised inside the mine 1, 4.
V—Install the network: Effectively distribute relays 3, 3′, antennas 2 and other elements that comprise the network.
VI—Operate the mine: This step consists of the mine exploitation phase 1, 4. In this phase, blocks of waste rock 10 or ore 11 material are removed, according to Mine Planning. Consequently, this step changes the mine topography 1, 4.
VII—Assess the network performance indicators: Collect real and simulated indicators, considering the changes in mine topography 1, 4.
VIII—Are indicators compatible with current and future requirements? This step consists of comparing the indicators collected with the performance requirements, so that the system operator may make a decision to optimize the system, if required. If the indicators are in accordance with the necessary requirements, it returns to step VI.
IX—Can the network be improved? This phase consists of the assessment of the network parameters, such as: positioning of nodes 3, 3′, 2, transmission power, inclination of antenna 2, transmission modes, or even to generate a favorable RF condition. If it is possible, go to step X to optimize the parameters; if not, assess if it is required to redesign the connectivity of the network infrastructure in step XI.
X—Network optimization: Change the parameters identified in step IX, returning to step VII to reassess the performance indicators.
XI—Collect update information of the mine: It is known that the real mine environment does not follow the Mine Planning exactly. Therefore, from time to time, it is necessary to assess how close is the Mine Planning from the real topography of the mine 1, 4. This information is very important for Network Planning.
XII—Does the network needs more from us? Based on information collected in step XI, assess if more nodes 3, 3′ and 2 are required in the network infrastructure. If more nodes 3, 3′, 2 are required, go to step XIII. If not, go to step XIV.
XIII—Add nodes: Add extra nodes 3, 3′, 2 to the network structure, then return to step V.
XIV—Is it required to redesign the network? In this step, it is assessed the requirement to redesign the network. One of the reasons that may result in this network redesign being unnecessary is the mine closure 1, 4. If it is required to redesign the network, go to step XV.
XV—Assess the topography within a planned schedule: In this step, the optimization structure will assess the mine topography in a planned period. Which will be the effects of this topography in the network? Will holes appear in the coverage in medium term? Will there be interference between nodes? In this case, will it be required to use another wireless channel, band or spectrum to avoid this interference? After this assessment, go to step XVI.
XVI—Is there any topography change? If there is any change, go to step XVII; if not, go to step II. This step considers the assessment of step XV and checks if there is any topography change that could improve costs and the performance of the wireless communication, such as maintenance or creation of absorption bulkheads 5′ in underground mines 4 to contain the interference.
XVII—Include network costs in Net Value function: In this step, considering the feasible topography changes assessed in steps XV and XVI, create an economic attribute for wireless network. in the Net Value function for each block (or set of blocks), and go to step I. With this new information, the Mine Planning software may optimize the Mine Planning.

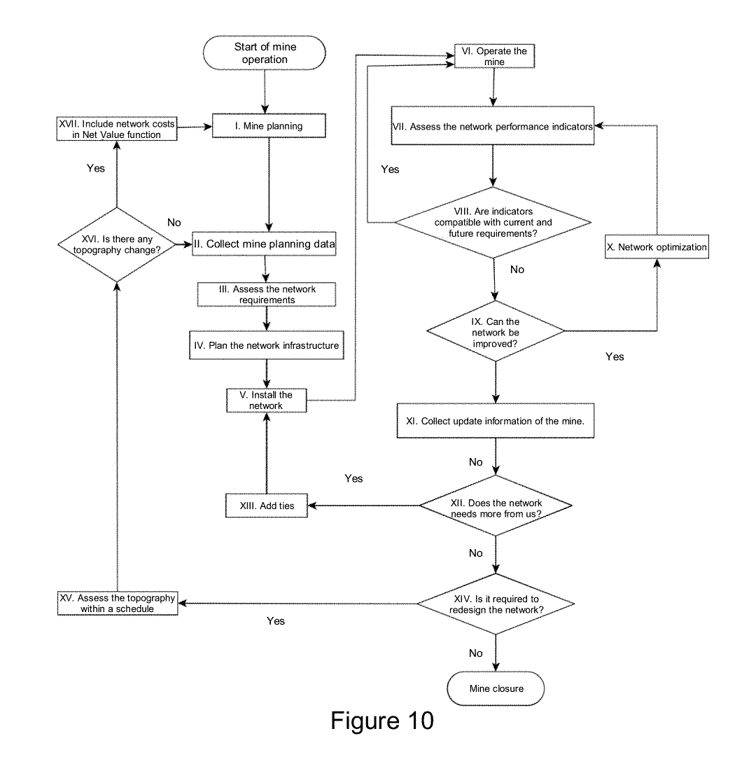

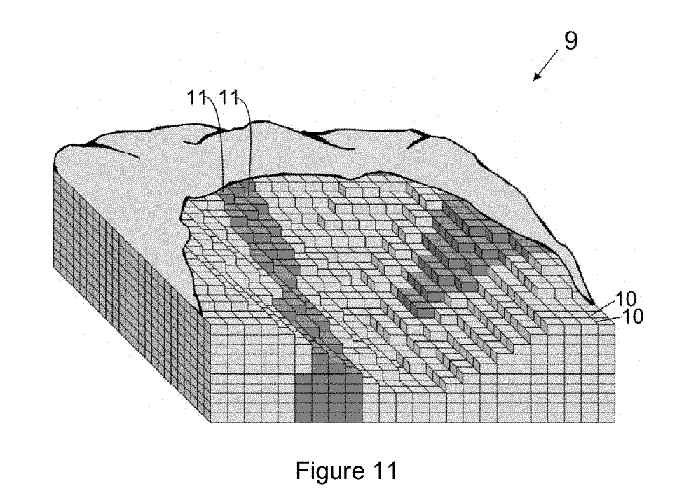

A representative flow chart of the steps listed is shown in FIG. 10 of this document.

Finally, it is concluded that the disclosure achieves all purposes it intends to achieve, revealing a Network Planning method associated to a Mine Planning method, set for cost reduction and quality optimization of wireless network distributed over a mine 1, 4.

Having described some examples of preferred achievement of these aspects, it is noteworthy that the scope of protection given by this document encompasses all other alternative forms appropriate to the execution of these aspects, which is defined and limited only by the content of the claim scope attached.

1. A method of Network Planning, comprising using information provided by a method of Mine Planning as input data.

2. The method of claim 1, wherein the method of Mine Planning receives inputs from the method of Network Planning.

3. The method of claim 2, wherein the inputs provided by the method of Network Planning to the method of Mine Planning are configured for creation of forms of generating a favorable RF condition.

4. The method of claim 3, wherein the favorable RF condition is provided by a reflexive bulkhead.

5. The method of claim 3, wherein the favorable RF condition is provided by an attenuation bulkhead.

6. The method of claim 3, wherein the favorable RF condition is provided by an additional tunnel comprised within an underground extraction mine.

7. The method of claim 1, wherein an interaction of the method of Network Planning with the method of Mine Planning reduces operational costs involved in an operation phase of a mine.

8. A method of Mine Planning, comprising using information provided by a Method of Network Planning as input data.

9. The method of claim 8, further comprising attributing a performance factor in a Net Value function which analyzes if removal or permanence of one or more blocks of a three-dimensional model causes a positive or negative condition of a wireless network performance.

10. The method of claim 8, further comprising attributing an economic factor in a Net Value function which analyzes Network Planning costs for each block or for a set of blocks of a three-dimensional model.

11. The method of claim 8, further comprising manipulating a mine topography and propagation of radio waves to minimize unintentional leaks and increase a security of information used by operations.

12. The method of claim 8, further comprising manipulating a mine topography and propagation of radio waves to block unintentional external signals of interference.
